(19) United States
(12) Patent Application Publication
(10) Pub. No.: US 2023/0035549 A1
(43) Pub. Date: Feb. 2, 2023

(54) PRINT FLUID DELIVERY WITH FLUID INDICATOR RESERVOIRS

(71) Applicant: HEWLETT-PACKARD DEVELOPMENT COMPANY, L.P., Spring, TX (US)

(72) Inventors: Wesley R. Schalk, Vancouver, WA (US); Roger Donat Gomez, Sant Cugat del Valles (ES); Paul Allan Osborne, Vancouver, WA (US)

(73) Assignee: HEWLETT-PACKARD DEVELOPMENT COMPANY, L.P., Spring, TX (US)

(21) Appl. No.: 17/791,084

(22) PCT Filed: Jan. 13, 2020
(86) PCT No.: PCT/US2020/013312

§ 371 Date: Jul. 6, 2022

(51) Int. Cl. B41J 2/175

(52) U.S. Cl. CPC B41J 2/17509; B41J 2/17566

(57) ABSTRACT

In one example in accordance with the present disclosure, a print fluid delivery system is described. The print fluid delivery system includes a main reservoir to hold a volume of print fluid to be supplied to a printhead and a fluid indicator reservoir fluidly coupled to the main reservoir. The fluid indicator reservoir visually indicates a fluid level through an aperture in a printing system housing. The fluid indicator reservoir and the main reservoir have a same fluid level. The print fluid delivery system also includes a fluid transport system to transport fluid through the print fluid delivery system.

### BACKGROUND

Printing systems refer to a combination of hardware components that form markings such as text, images, or other patterns on a target surface. Different printing systems dispense different types of print compound on the target surface. For example, a two-dimensional (2D) printer provides wet print compound such as ink, or dry compound such as toner, to form images/text on print media. In another example, a three-dimensional (3D) printer provides fluid, such as a fusing agent, or a dry material such as particulate build material into a bed. Over time, the print compound that is deposited on the target is depleted.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a print fluid delivery system with a fluid indicator reservoir, according to an example of the principles described herein.

FIG. 2 is an isometric view of a printing system with fluid indicator reservoirs, according to an example of the principles described herein.

FIG. 3 is a cross-sectional view of a printing system with fluid indicator reservoirs, according to an example of the principles described herein.

FIGS. 4A and 4B are cross-sectional views of fluid indicator reservoirs, according to an example of the principles described herein.

FIGS. 5A and 5B are diagrams of a printing system with a fluid indicator reservoir during printing, according to an example of the principles described herein.

FIG. 6 is a diagram of a printing system with a fluid indicator reservoir during printing, according to another example of the principles described herein.

FIG. 7 is a diagram of a printing system with a fluid indicator reservoir during refilling, according to an example of the principles described herein.

FIG. 8 is a diagram of a printing system with a fluid indicator reservoir during refilling, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Printing systems in general dispense print compound onto a surface in the form of images; text, or other patterns. Different printing systems dispense different print compounds. For example, the print compound may be dry, or particle-based such as toner. In other examples, the print compound may be a liquid, such as liquid ink. Other types of compound may also be deposited on the surface via a printing system. For example; a three-dimensional printer may deposit a powder material that is to be sintered, fused, or otherwise solidified. Such a three-dimensional printer may also deposit an agent, that is dry or wet, which facilitates the solidifying of the powder material into a three-dimensional object.

These printing systems may include a reservoir or other container that holds the print fluid to be deposited on a target surface. In some cases, the reservoirs may be on board the printing system. Over time, as print jobs are executed, the level of print fluid in the reservoir drops. If not replenished, the printing system may be limited in the amount of print jobs that can be processed. Accordingly, the reservoir may be refilled with additional print fluid.

While such printing systems, with their ability to be refilled with print fluid, can allow a user to print hundreds or thousands of pages of documents, some characteristics impact their throughput. For example, if a print fluid level drops to a certain level where it is to be replenished, and a user is unaware and does not have print fluid on hand, printing may be interrupted while the user acquires the replacement print fluid and refills the reservoir. Moreover, printing when the fluid level is below a certain threshold may impact print quality. Accordingly, the present specification describes a system for continuously indicating fluid level such that a user is aware of the fluid level and can take any number of actions based on the fluid level information. That is, such fluid indication is provided when the printing system is powered on or off.

The present specification describes an example print fluid delivery system that includes a main reservoir to hold a volume of fluid to be used during printing. A fluid indicator reservoir is coupled to the main reservoir and maintains a same fluid level as the main reservoir. The fluid indicator reservoir may be transparent and aligned with an aperture in the printing system housing.

Given that the fluid indicator reservoir is at a same level as the main reservoir and is visible through apertures in the printing system housing, the present system provides direct, and not electronic, indication of print fluid available to the printing system. In some examples, this fluid indicator reservoir may be smaller than the main reservoir and thus may be more readily positioned at different locations within the printing system.

Such a fluid indicator reservoir may be particularly useful in large format printers. For example, large format printers may include large capacity reservoirs that are not readily visible from the front of the printing system without increasing the width of the printing system. However, a fluid indicator reservoir, which is smaller in size than these main large capacity reservoirs, can be placed anywhere on the printing system, including the front of the printing system, thus providing accurate and user-friendly indication of print fluid levels.

The present specification describes a print fluid delivery system. The print fluid delivery system includes a main reservoir to hold a volume of print fluid to be supplied to a printhead and a fluid indicator reservoir fluidly coupled to the main reservoir. The fluid indicator reservoir visually indicates a fluid level through an aperture in a printing system housing. The fluid indicator reservoir and the main reservoir have a same fluid level. The print fluid delivery system also includes a fluid transport system to transport fluid through the print fluid delivery system.

The present specification also describes a print fluid delivery system. In this example, the print fluid delivery system includes a main reservoir to hold a volume of print fluid to be supplied to a printhead and a fluid indicator reservoir fluidly coupled to the main reservoir. As described above, the fluid indicator reservoir visually indicates a fluid level through an aperture in a printing system housing. In this example, 1) the fluid indicator reservoir is light-permeable, 2) the fluid indicator reservoir and the main reservoir are maintained at a same pressure, and 3) the fluid indicator reservoir and the main reservoir have a same elevation. The print fluid delivery system also includes a fluid transport system to 1) transport print fluid from the main reservoir to the printhead and 2) circulate print fluid through the print fluid delivery system during printing and refilling.

The present specification also describes a printing system. The printing system includes a housing having a fluid level aperture on a front surface. A main reservoir holds a volume of print fluid to be supplied to a printhead and a fluid indicator reservoir which is fluidly coupled to the main reservoir via respective floor surfaces, visually indicates a fluid level through the fluid level aperture. In this example, 1) the fluid indicator reservoir is light-permeable, 2) the fluid indicator reservoir and the main reservoir have a same elevation, and 3) the fluid indicator reservoir and the main reservoir are vented to atmosphere. The printing system also includes a fluid transport system to transport fluid through the print fluid delivery system.

Such systems and methods 1) enable accurate indication of print fluid levels in a printing system; 2) allow for indicating fluid levels at any location on the printing system; 3) provide for a mechanically simple fluid level indication; and 4) indicate print fluid levels when the printing system is powered on or off.

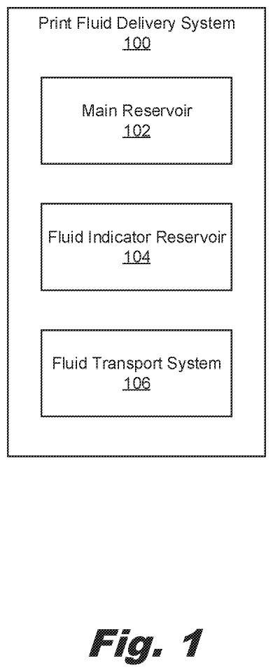

Turning now to the figures, FIG. 1 is a block diagram of a print fluid delivery system (100) with a fluid indicator reservoir (104), according to an example of the principles described herein. As described above, the print fluid within a printing system may become depleted over time. If a user is unaware of the print fluid level, certain complications may arise such as reduced print quality and printing interruption as a user acquires and refills the main reservoir (102). The print fluid delivery system (100) of the current specification provides for an accurate, simple, and user-friendly indication of print fluid levels within the print fluid delivery system (100) such that operation of the printing system can be carried out based on accurate information regarding print fluid levels. For example, knowing with accuracy that a print fluid level is approaching a replacement level, a user may re-order print fluid in advance. Accordingly, when the replacement level is reached, there is minimal interruption to the printing operations as the user has the replacement print fluid on hand.

The print fluid delivery system (100) includes a main reservoir (102) to hold a volume of print fluid that is to be supplied to a printhead. That is, a printhead includes components that eject print fluid onto a target surface, whether that surface be a two-dimensional surface such as paper, a powder bed for additive manufacturing, or any other type of target surface. The main reservoir (102) maintains a volume of the print fluid that is available to the printhead for such deposition.

The print fluid that is supplied may be of a variety of types. For example, it may be a fusing agent or colored ink. In some examples, multiple print fluid delivery systems (100) may be implemented in a printing system. For example, a color printer may have different print fluid delivery systems (100), and different main reservoirs (102), each supplying a respective printhead with a different colored ink.

The print fluid delivery system (100) also includes a fluid indicator reservoir (104) that as described above, is fluidly connected to the main reservoir (102) and is an intermediate repository of print fluid, which is directly coupled to the printhead. In other words, during printing, print fluid is drawn from the main reservoir (102), passes to the fluid indicator reservoir (104), and then goes to the printhead for ejection.

The fluid indicator reservoir (104) provides a direct physical indication of fluid level. Specifically, the fluid indicator reservoir (104) may provide such a visual indication through an aperture in a printing system housing. That is, the housing of the printing system may include an aperture. This fluid indicator reservoir (104) may be aligned with this aperture. Moreover, the fluid indicator reservoir (104) may be light-permeable. That is, the fluid indicator reservoir (104) may be formed of a transparent or a translucent material. Based on the light-permeability, a user may see the contents of the fluid indicator reservoir (104) and more particularly may see the quantity of the contents of the fluid indicator reservoir (104) through the aperture.

Indicating fluid level through the fluid indicator reservoir (104) as opposed to the main reservoir (102) may increase the quality of the print fluid through the system. For example, a reservoir formed out of light-permeable material may result in more water loss to the print fluid contained therein as compared to an opaque reservoir. Water loss from the print fluid alters the chemical composition of the print fluid which may result in reduced print quality and/or reduced printing system reliability.

The water loss from a light-permeable reservoir is related to the surface area of the reservoir. Accordingly, water loss from a light-permeable main reservoir (102), which is large, is greater than water loss from a light-permeable fluid indicator reservoir (104), which is smaller than the main reservoir (102). In other words, as the fluid indicator reservoir (104) is light-permeable and provides print fluid level indication, the main reservoir (102) may be made out of another material, such as an opaque material, for example a metal, to reduce or prevent water loss from this larger main reservoir (102).

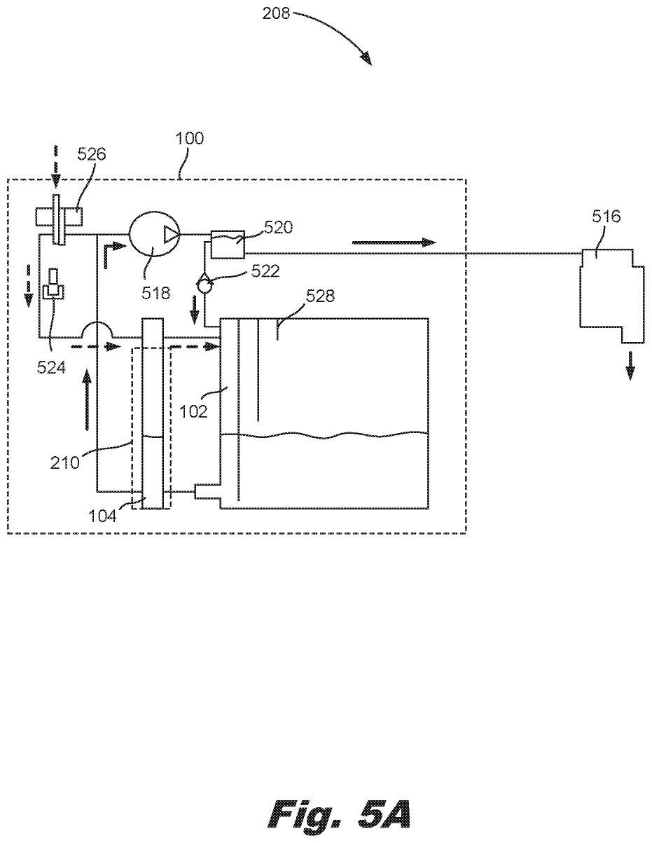

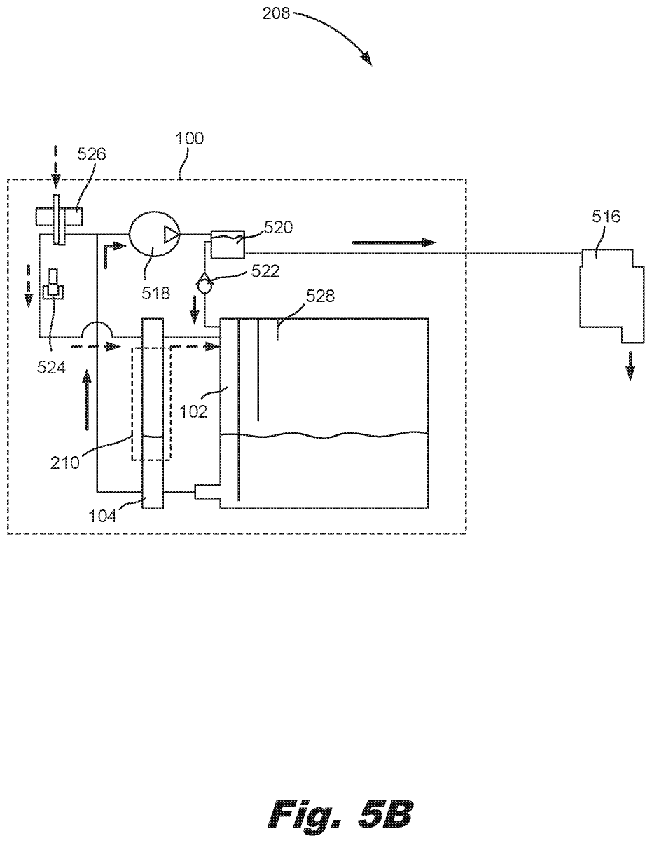

To provide accurate information regarding print fluid level in the main reservoir (102), the fluid indicator reservoir (104) may have the same fluid level as the main reservoir (102). In some specific examples, notwithstanding the two reservoirs (102, 104) having the same fluid level, the fluid indicator reservoir (104) may communicate that the print fluid level in the main reservoir (102) is low before the main reservoir (102) is low to provide an early warning to the user. For example, an aperture in a printing system housing that aligns with the fluid indicator reservoir may be positioned higher than a floor of the fluid indicator reservoir (104) to provide this early warning. This example is depicted in FIGS. 5A and 5B below.

Returning to the example where the fluid indicator reservoir (104) and the main reservoir (102) have a same elevation, in some examples, the fluid indicator reservoir (104) and the main reservoir (102) may be maintained at a same pressure. Given these conditions, as print fluid is drawn from the print fluid delivery system (100) by a pump and/or the printhead, the fluid level in each reservoir will drop at a similar rate, and ultimately rest at the same fluid level. Moreover, during refill, each reservoir will rise at a similar rate and ultimately rest at the same fluid level. Accordingly, the fluid indicator reservoir (104), by being transparent, at the same elevation as the main reservoir (102), and at the same pressure as the main reservoir (102) provides a direct, and not electronic, representation of the quantity of print fluid available for use by the printing system.

Such a direct print fluid level indication is convenient and accurate. For example, in electronic print fluid indications, a user may have to navigate through multiple menus within a display to view print fluid levels. In other examples, a simple LED may indicate when fluid level is low. However, this does not indicate a fluid level and may not allow users enough warning to purchase new ink and refill a reservoir prior to running out of the print fluid. Moreover, electronic fluid level indications may not function when printers are in a sleep or powered off state, Electronic fluid level indications are also more complex and rely on extra circuitry and programming to implement. Still further, electronic fluid level indications may be incremental, and not continuous. For example, an electronic fluid level indicator may indicate that a fluid reservoir is empty, 25% full, 50% full, 75% full, or 100% full. Thus, the resolution of fluid level indication in an electronic fluid level system may be reduced.

As described above, the fluid indicator reservoir (104) may be smaller than the main reservoir (102) and thus more readily positioned at different locations within the printing system. For example, for ease of use, it may be desired to position the fluid level indication mechanism near a front of the printing system.

However, the main reservoir(s) (102) of the printing system, which may be disposed along a side of the printing system, can be large. For example, in some large format printers, the main reservoirs (102) may contain between 0.5 and 2.0 liters of print fluid. Accordingly, moving these main reservoirs (102) from the side to the front, may trigger a re-sizing of the front of the printing system to accommodate the main reservoirs (102). This may increase the width of the printing system, which may be undesirable.

In contrast, the fluid indicator reservoir(s) (104), by being smaller, are more readily positioned. Accordingly, the fluid indicator reservoir (104) may be positioned at the front of the printing system without size increase and in some cases may be positioned without any modification to the printing system at all. In this example, fluid lines and vent lines may couple the fluid indicator reservoir (104) to the main reservoir (102) as described above to provide the direct fluid level indication. Thus, the present print fluid delivery system (100) provides a way to indicate fluid level at any location within a printing system by conveniently positioning a bulky main reservoir(s) (102).

The print fluid delivery system (100) also includes a fluid transport system (106) to transport the print fluid through the print fluid delivery system (100). That is, the fluid transport system (106) includes various tubes, valves, pumps, and other fluid components to move the print fluid from the main reservoir (102) to the printhead. As described above, along this path, the print fluid passes to the fluid indicator reservoir (104).

In some examples, the fluid transport system (106) circulates the print fluid through the print fluid delivery system (100) during printing and refilling. That is, there may be negative effects if print fluid is left to sit in the print fluid delivery system (100) and/or the printhead. For example, as fluid sits, the pigment components of the fluid may settle. This settling creates disparity in the coloring effect of the print fluid, thus generating inconsistency in printed marks. Further, the settling of the print fluid may clog certain components. Accordingly, the fluid transport system (106) by constantly circulating print fluid through the print fluid delivery system (100) prevents settling and other negative effects, and provides fresh and mixed print fluid to the printhead at all times.

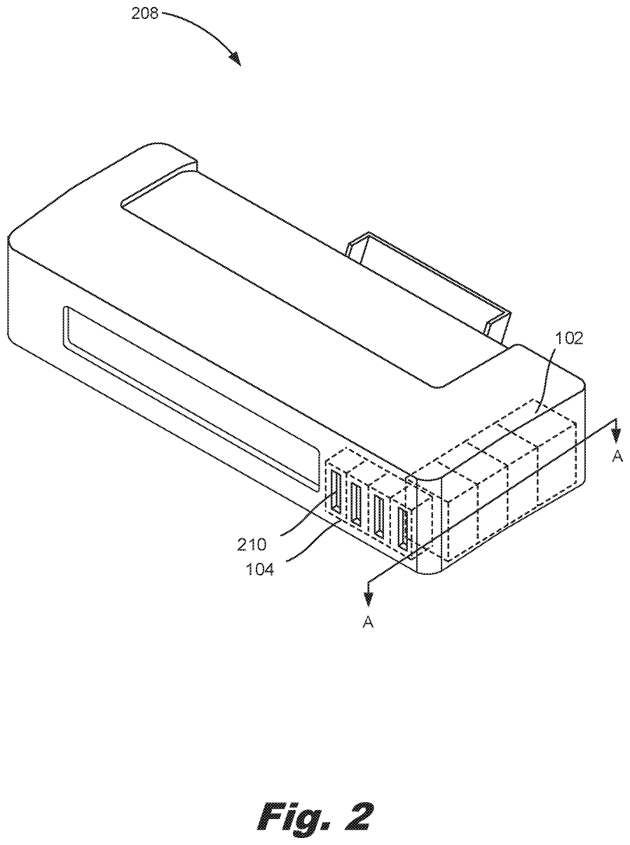

FIG. 2 is an isometric view of a printing system (208) with a fluid indicator reservoir (104), according to an example of the principles described herein. As described above, the printing system (208) may include a housing that houses the various components used to generate printed marks on a target surface. While FIG. 2 depicts a large format printing system (208), the printing system (208) that implements the print fluid delivery system (FIG. 1, 100) as described herein may take on a variety of forms. In the example depicted in FIG. 2, the main reservoirs (102) may be large capacity, on the scale of 0.5 to 2.0 liters and may be disposed in a side region of the printing system (208). To move the main reservoirs (102) towards the front of the printing system (208) depicted in FIG. 2 may result in changes to a width of the printing system (208) which may be undesirable The fluid indicator reservoirs (104) which are smaller however, may be more easily positioned anywhere in the printing system (208), for example near the front. For simplicity, in FIG. 2 just one instance of a fluid indicator reservoir (104) and main reservoir (102) are indicated with a reference number.

Decoupling the fluid level indication from the main reservoir (102) allows each of the main reservoir(s) (102) and the fluid indicator reservoir(s) (104) to be placed anywhere within the printing system (208) to optimize main reservoir (102) capacity, product size, system cost, and ease of fluid level indication. For example, as depicted in FIG. 2, the fluid indicator reservoirs (104) have been placed in the front of the printing system (208) while the main reservoirs (104) may be mounted along the right side of the printing system (208) where there is adequate space to fit the main reservoirs (102).

Accordingly, the fluid indicator reservoirs (104) may be formed out of a light-permeable material such as polypropylene and may be viewable through apertures (210) in the housing of the printing system (208). For simplicity, a single instance of an aperture (210) is indicated with a reference number. In some examples, the aperture(s) (210) may include markings to indicate relative fluid levels within the respective fluid indicator reservoir(s) (104).

While the example in FIG. 2 depicts a printing system (208) with four fluid indicator reservoirs (104) and four corresponding main reservoirs (102), the printing system (208) may include any number of paired reservoirs (102, 104). For example, a monochromatic printing system (208) may include a single main reservoir (102) and a single fluid indicator reservoir (104) and a single aperture (210).

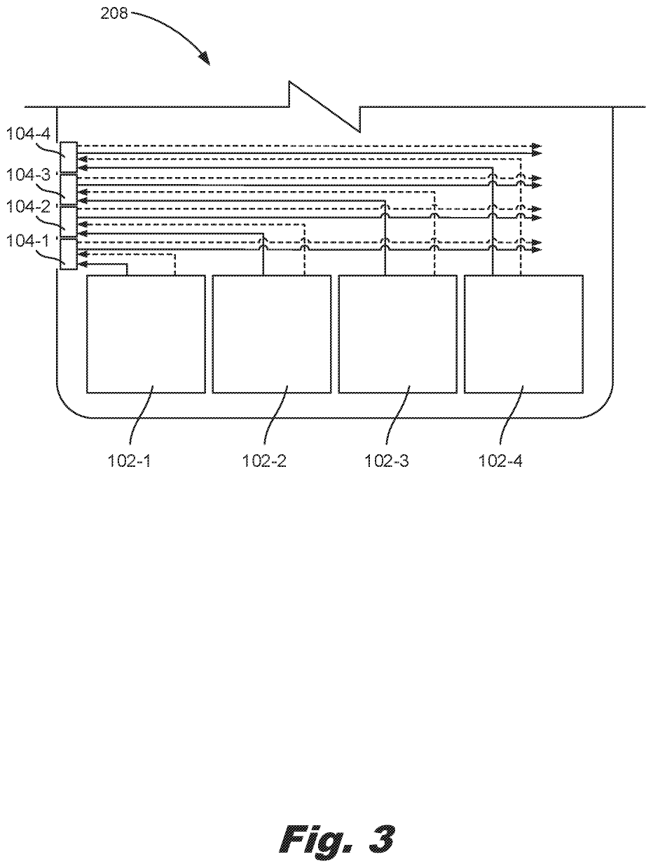

FIG. 3 is a cross-sectional view of a printing system (208) with fluid indicator reservoir(s) (104-1, 104-2, 104-3, 104-4), according to an example of the principles described herein. Specifically, FIG. 3 is a cross-sectional diagram taken along the line A-A in FIG. 2. FIG. 3 depicts the housing of the printing system (208) with the fluid level apertures (FIG. 2, 210) that are on the front surface and through which the fluid indicator reservoirs (104-1, 104-2, 104-3, 104-4) are viewable.

FIG. 3 also clearly depicts the main reservoirs (102-1, 102-2, 102-3, 102-4) that are disposed along a side of the printing system (208) and that hold a volume of print fluid to be supplied to a printhead. As described above and as depicted in FIG. 3, the main reservoirs (102) may have a large capacity and not readily positioned along the front of the printing system (208) without increasing the width of the printing system.

Direct level indication of the remaining quantity of print fluid in these main reservoirs (102) from the front may trigger smaller reservoir capacities, an increase in the width of the printing system (208), or a redesign of the main reservoirs (102) with long and narrow reservoirs extending from the front of the printing system (208) to the rear. However, long and narrow main reservoirs (102) are more complex and may rely on more expensive manufacturing processes to form the reservoir (102) body and seal the top lid.

However, the fluid indicator reservoirs (104) as described herein, by being smaller can be more readily positioned at other locations within the printing system (208). Accordingly, the main reservoirs (102) and the fluid indicator reservoirs (104) may be positioned at different locations within the printing system (208) housing.

The fluid indicator reservoir (104) may be smaller than the respective main reservoir (102) by any amount. For example, the fluid indicator reservoir (104) may be 20-30% smaller than the respective main reservoir (102), While specific reference is made to a particular relative size of the fluid indicator reservoir (104), the fluid indicator reservoir (104) may be smaller by different percentages so long as the print fluid is readily visible through the aperture (FIG. 2, 210) and that capillary action within the fluid indicator reservoir (104) does not impact fluid levels. For example, capillary forces on the walls of the fluid indicator reservoirs (104) may draw fluid up the walls. If the fluid indicator reservoirs (104) are too narrow, the meniscus that is formed around the walls may impact the fluid level indicated. Accordingly, the size, and more particularly a width, of the fluid indicator reservoir (104) may be selected so as to avoid this capillary meniscus from altering the fluid level indicated. In another example, the size, and more particularly a width, of the fluid indicator reservoir (104) may be selected to provide clear visibility from different angles and distances.

As described above, the fluid indicator reservoirs (104) are fluidly coupled to a respective main reservoir (102) via their floor surfaces. That is, the fluid transport system (FIG. 1, 106) includes tubes that connect the various components of the print fluid delivery system (FIG. 1, 100). Part of this fluid transport system (FIG. 1, 106) is a tube between the main reservoir (102) and the fluid indicator reservoir (104). Such a tube may be coupled to each reservoir (102, 104) near a floor surface. Via this floor-connected fluid tube, fluid levels between the main reservoir (102) and the fluid indicator reservoir (104) equalize. This occurs as the fluid indicator reservoir (104) and the main reservoir (102) have a same elevation and are maintained at the same pressure.

Note that while the fluid indicator reservoir (104) and the main reservoir (102) may be at the same elevation, it may be desirable for the fluid indicator reservoir (104) to indicate that a main reservoir (102) has been depleted before it has actually been depleted. Doing so may allow a user to obtain replacement print fluid and continue to print awaiting delivery of the replacement print fluid. This may be accomplished by altering the aperture in the printing system housing through which the fluid indicator reservoir (104) is viewable as depicted in FIGS. 5A and 5B.

As described above, a pressure above the fluid in both the fluid indicator reservoir (104) and the main reservoir (102) may be the same. In some examples, the fluid indicator reservoirs (104) and the main reservoirs (102) are maintained at atmospheric pressure. However, the reservoirs (102, 104) may be held at other pressures as well, both positive and negative. Atmospheric pressure may be maintained in a variety of ways. For example, each fluid indicator reservoir (104) and each main reservoir (102) may be individually coupled to a vent line. In other examples, a vent line may pass through a main reservoir (102) and a fluid indicator reservoir (104), which vent line is exposed to the atmosphere. In this example, a first main reservoir (102-1) and a first fluid indicator reservoir (104-1) may have one vent line and a second main reservoir (102-2) and a second fluid indicator reservoir (104-2) may have a second vent line. In FIG. 3, each vent line is indicated with a dashed line.

By comparison, fluid lines are indicated with solid lines. As described above, print fluid initially resides in a main reservoir (102). From here, it follows a fluid line to the fluid indicator reservoir (104), Via action of a pump or the printhead, fluid is drawn from a respective fluid indicator reservoir (104) to the printhead for ejection onto a target surface.

FIG. 3 clearly depicts how a fluid indicator reservoir (104) may be implemented to allow viewing print fluid levels from the front of the printing system (208) without increasing the size of the printing system (208). That is, the print fluid delivery system (FIG. 1, 100) decouples direct fluid level indication from the main reservoir (102) where the print fluid is primarily retained. Still further, each fluid indicator reservoir (104) holds a volume of print fluid such that the overall fluid capacity of the printing system is increased such that the printing system (208) can go a longer period of time between refills.

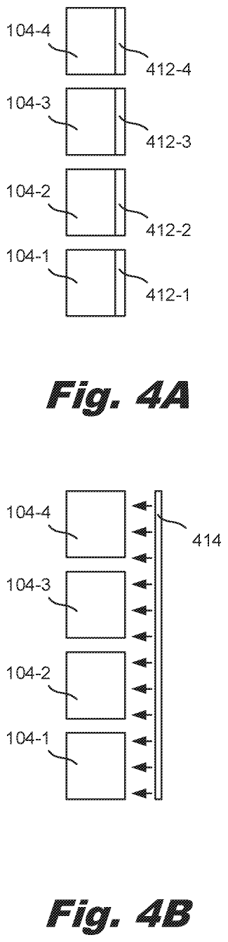

FIGS. 4A and 4B are cross-sectional views of fluid indicator reservoirs (104), according to an example of the principles described herein. Specifically, FIGS. 4A and 4B are cross-sectional views taken along the line A-A in FIG. 2. As described above, the fluid indicator reservoirs (104) may be formed of a light-permeable material that is translucent or transparent. In some examples, additional components may be used to further increase the visibility of the print fluid in the fluid indicator reservoir (104). For example, as depicted in FIG. 4A, each fluid indicator reservoir (104) may include a contrasting back surface (412). In the case of black, cyan, magenta, or yellow print fluid, the back side of the fluid level indicator reservoir (104) may be covered with a white heat stake film or laser welded lid. With a shallow fluid indicator reservoir (104), the white film or lid enhances the visibility of fluid levels without the aid of lighting. While particular reference is made to a white contrasting surface (412), the contrasting surface (412) may be of different colors or types. For example, if a white print fluid is contained in a fluid indicator reservoir (104), the contrasting surface (412) may be a black film or covering.

FIG. 4B depicts another example of a component to increase the visibility of the print fluid in the fluid indicator reservoirs (104). In this example, a light source (414) backlights the fluid indicator reservoirs (104). This light source (414) transmits light through the back of the light-permeable fluid indicator reservoir (104) to illuminate and increase the visibility of the contents therein. In this example, a single light source (414), which may be a light emitting diode (LED), may be placed behind the bank of fluid indicator reservoirs (104-1, 104-2, 104-3, 104-4). In some examples, the light source (414) is selectively activated and may be triggered based on any number of conditions. Examples of such conditions that may trigger the activation of the light source include printing, reloading print fluid into the printing system, an indication that the print fluid level is below a threshold value, opening of an access door and/or reception of a user input at a printing system user interface.

While FIG. 4B depicts a single light source (414) for a bank of fluid indicator reservoirs (104). In some examples, each fluid indicator reservoir (104) may be lit by a dedicated light source (414). Doing so may allow for individual illumination of a particular fluid indicator reservoir (104) in the event of low print fluid in an associated main reservoir (102).

FIGS. 5A and 5B are diagrams of a print fluid delivery system (100) with a fluid indicator reservoir (104) during printing, according to an example of the principles described herein. Specifically, FIGS. 5A and 5B depict the print fluid delivery system (100) along with the printhead (516) that ejects the print fluid.

The printhead (516) may include any number of components to effectuate fluid ejection. For example, the printhead (516) may include a number of nozzles. A nozzle may include an ejector, a firing chamber, and an opening. The opening may allow fluid, such as ink, to be deposited onto a surface, such as a print medium. The firing chamber may include a small amount of fluid. The ejector may be a mechanism for ejecting fluid through the opening from the firing chamber, where the ejector may include a firing resistor or other thermal device, a piezoelectric element, or other mechanism for ejecting fluid from the firing chamber.

For example, the ejector may be a firing resistor. The firing resistor heats up in response to an applied voltage. As the firing resistor heats up, a portion of the fluid in the firing chamber vaporizes to form a bubble. This bubble pushes liquid fluid out the opening and onto the print medium. As the vaporized fluid bubble pops, fluid is drawn into the firing chamber and the process repeats. In this example, the printhead (516) may be a thermal inkjet (TIJ) printhead (516).

In another example, the ejector may be a piezoelectric device. As a voltage is applied, the piezoelectric device changes shape which generates a pressure pulse in the firing chamber that pushes a fluid out the opening and onto the print medium. In this example, the printhead (516) may be a piezoelectric inkjet (PIJ) printhead (516).

FIGS. 5A and 5B also clearly depicts the main reservoir (102) and the fluid indicator reservoir (104) which are fluidly coupled via a fluid line near a bottom of each reservoir (102, 104). Due to the position of this fluid line, the pressure and weight of the fluid ensure that the fluid levels in each of these reservoirs (102, 104) equalizes to the same level. While the fluid levels in these reservoirs (102, 104) may rise and fall at different rates, due to the fluid conditions in the print fluid delivery system (FIG. 1, 100), these fluid levels will stabilize to the same level.

FIGS. 5A and 5B also depicts the fluid transport system (FIG. 1, 106) and more specifically the fluid lines to transport print fluid from the main reservoir (102), through the fluid indicator reservoir (104), and to the printhead (516).

In some examples, the printing system (208) may include additional components to aide in the transportation of fluid through the print fluid delivery system (100) and the printhead (516). For example, the print fluid delivery system (100) may include a fluid pump (518) which circulates fluid through the print fluid delivery system (100). That is, during printing the fluid pump (518) draws fluid from the fluid indicator reservoir (104) and towards the printhead (516), in some examples passing other components along the way.

The print fluid delivery system (100) may also include an air separator (520). If there is no fluid being drawn from the fluid indicator reservoir (104), air, rather than print fluid would be pumped to the printhead (516). If air is allowed into the printhead (516), the printhead (516) may become damaged. That is, air in the printing system may affect print quality and printhead life. For example, in some cases the print fluid acts as a coolant to nozzles of the printhead (516) and a lack of print fluid, i.e., the presence of air, may cause the nozzles to overheat, thereby shortening their life span. Moreover, the lack of a continuous supply of print fluid to the printhead (516) may cause the print fluid in the printhead to dry, crust, and potentially block nozzles, heaters, or other components in the printhead. As yet another example, the introduction of air may prevent print fluid from entering the firing chamber in the printhead.

The air separator (520) prevents this. For example, even while air is being pumped into the air separator (520), print fluid may still reside in the bottom of the air separator (520). This print fluid is drawn into the printhead (516). The air, by comparison, being above the print fluid is passed through the return line into the main reservoir (102).

The print fluid delivery system (100) may also include a pressure control device (522) to regulate pressure in the printing system (208). That is, the pressure control device (522) ensures that print fluid does not leak out the printhead (516) and also ensures that the printhead (516) is not starved of print fluid. This pressure control device (522) may be disposed along the return line between the air separator (520) and the main reservoir (102). In some examples, the pressure control device (522) may be a ball on a seat with a spring behind it. As fluid pushes harder against the ball, the spring compresses and fluid can pass into the main reservoir (102). Such a pressure control device (522) ensures a constant pressure in the fluid transport system (FIG. 1, 106) tubes and thereby a constant pressure differential which transports the print fluid along to the printhead (516). That is, the pressure control device (522) keeps the print fluid at a particular pressure, which particular pressure drives fluid through the fluid lines at a flowrate selected for the printhead (516).

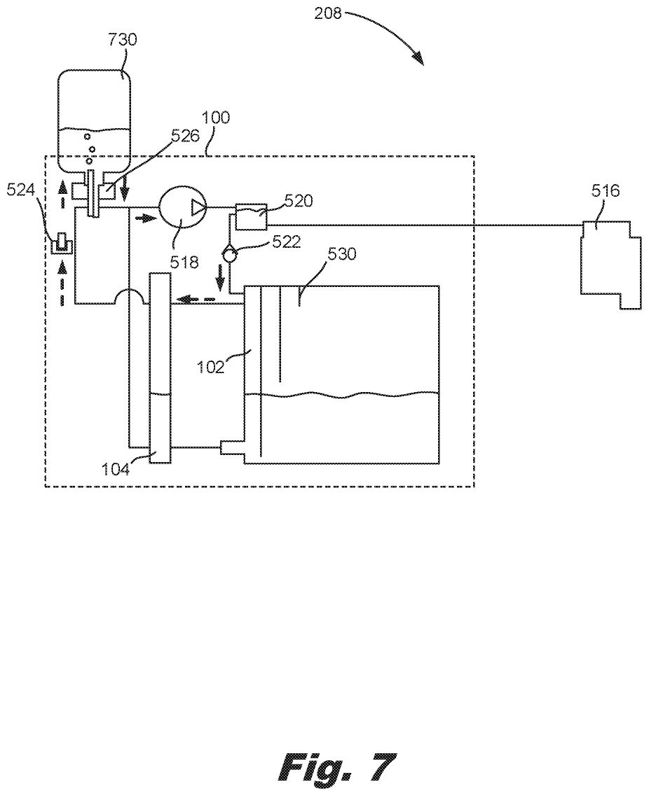

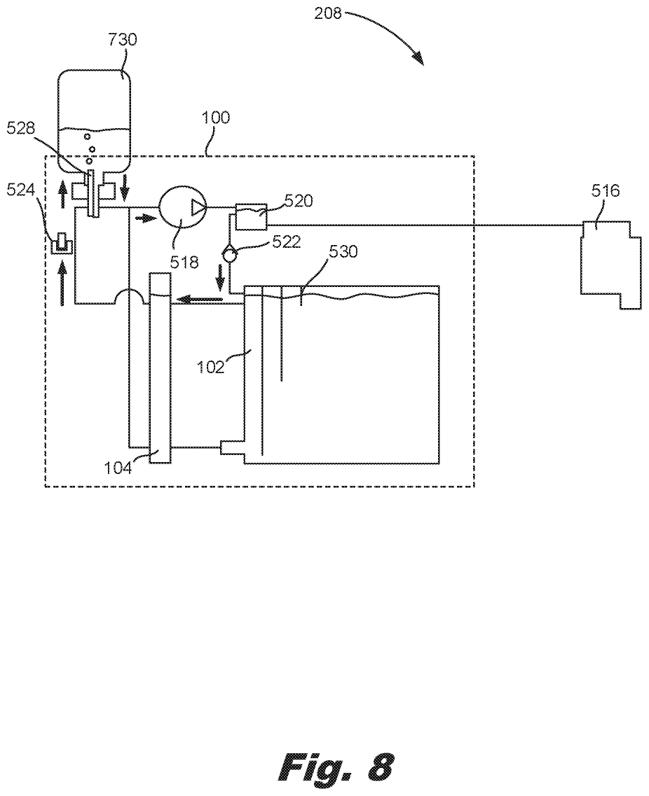

The print fluid delivery system (100) may also include a switch (524) to selectively decouple a refill port (526) from the fluid transport system (FIG. 1, 106). That is, the print fluid delivery system (100) includes a refill port (526) through which replacement fluid may be drawn to refill the reservoirs (102, 104). The switch (524) may detect when a refill container is attached to refill port (526). A closed switch (524) as indicated in FIGS. 7 and 8, indicates a refill container is attached and the pump (518) activates to initiate a refill operation. The refill port (526) automatically closes the refill line when the refill container is not attached. Note that in this example, the vent line remains open, unless a shipping cap is attached, to allow air to pass so as to maintain the fluid indicator reservoir (104) and the main reservoir (102) at atmospheric pressure. In some examples, the switch (524) may be an opto-mechanical electrical switch.

The print fluid delivery system (100) may also include a fluid level sensor (528) to detect a fluid level in the reservoirs (102, 104). While the fluid indicator reservoir (104) provides one way of determining fluid levels, the fluid level sensor (528) may provide another way. In this example, the fluid level sensor (528) may output an electrical signal which may be used to provide another notification to the user and/or provide control over the printing system (208). For example, based on an output of this sensor, printing may be interrupted if fluid levels are too low. While FIG. 5 depicts the fluid level sensor (528) in the main reservoir (102), the fluid level sensor (528) may be disposed in the fluid indicator reservoir (104).

As described above, FIGS. 5A and 5B depict a printing system (208) during printing. An example of the operation of the different components during printing is now presented. In FIGS. 5A and 5B, print fluid flow is indicated by solid arrows whereas air flow is indicated by dashed arrows.

In this example, the pump (518) draws print fluid from the fluid indicator reservoir (104) which draws fluid from the main reservoir (102). When print fluid is ejected out of the printhead (516), it creates a negative pressure that draws fluid into the printhead (516) from the printhead line. If a fluid level in the air separator (520) rises to a certain level, overflow fluid may be returned to the main reservoir (102). In this way, print fluid is continually moving through the print fluid delivery system (100) so fluid does not settle and separate, which as described above, may result in print quality defects and could affect printing system (208) performance and life.

Note that during printing, because the fluid indicator reservoir (104) and the main reservoir (102) are maintained at the same pressure, the respective fluid levels will drop at a similar rate. Accordingly, vent lines couple the reservoirs (102, 104) to atmosphere, which in this case is through the refill port (526). Note that while FIGS. 5A and 5B depicts a single vent line to pass through both a fluid indicator reservoir (104) and a main reservoir (102), in some examples, each reservoir may be independently vented. Accordingly, as fluid drops in the fluid indicator reservoir (104) and the main reservoir (102), air is drawn into the reservoirs (102, 104) to maintain atmospheric pressure. Again, note that the refill port (526) includes multiple sub-ports. When printing, a fluid sub-port may be closed, but an air sub-port may be opened to ensure air may be drawn into or vented out the air sub-port. During printing system transport or storage, a cap may be included that closes the air sub-port to prevent fluid leakage.

As described above, the printing system (208) may provide an indication that the main reservoir (102) is low, before it is actually low to provide an early warning system to a user. For example, as depicted in FIG. 5A, the aperture (210) floor may be placed near the floor of the reservoirs (102, 104) such that the distance between the floor of the aperture (210) and the fluid level indicates what is actually available in the reservoirs (102, 104).

However, as depicted in FIG. 5B, the floor of the aperture (210) may be higher than the floor of the reservoirs (102, 104). Accordingly, in this example, the distance between the floor of the aperture (210) and the fluid level may indicate a lower height, and less volume, of fluid than is actually present. In this example, the fluid indicator reservoir (104) and the aperture (210) may indicate a low print fluid status before the main reservoir (102) is actually low. In some examples, the marking alongside the aperture (210) on the printing system housing may also be used to provide early warning.

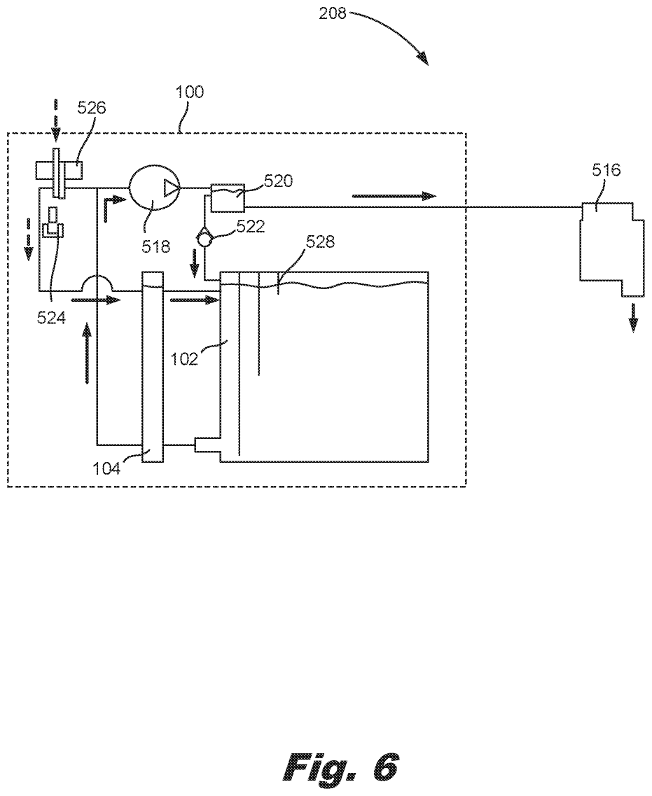

FIG. 6 is a diagram of a print fluid delivery system (100) with a fluid indicator reservoir (104) during printing, according to another example of the principles described herein. Specifically, FIG. 6 depicts a vent line purge in the event that print fluid enters the vent line from the fluid indicator reservoir (104) and/or the main reservoir (102). That is, if overflow print fluid enters the vent line, the vent line will purge during printing.

The purge operation may happen automatically during printing. For example, when a print fluid is ejected from the printhead (516), replacement print fluid is drawn from the printhead line. The pump (518) and pressure control device (522) maintain fluid pressure to the printhead (516). As print fluid is depleted from the main reservoir (102) and the fluid indicator reservoir (104) during printing, a vacuum is formed in the air above the print fluid in the reservoirs (102, 104). This vacuum will initially draw print fluid from the vent lines into either the main reservoir (102) or the fluid indicator reservoir (104) until all print fluid is withdrawn from the vent line(s). Air will be drawn into the refill port (526) to replace print fluid that is ejected during printing. This air will eventually fill the vent line and allow atmospheric pressure in both reservoirs.

FIG. 7 is a diagram of a print fluid delivery system (100) with a fluid indicator reservoir (104) during refilling, according to an example of the principles described herein. That is, as fluid is depleted from the reservoirs (102, 104), a refill container (730) may be inserted into the refill port (526) to refill both reservoirs (102, 104). In this example, the switch (524) may be closed indicating that the refill container (730) is attached. During a refill operation, print fluid passes from the refill container (730) to the main reservoir (102) and may pass through other components such as the air separator (520) along the way.

Specifically, during reservoir (102, 104) fill, the refill container (730) is in fluid communication with the refill port (526). The pump (518) remains active during refill and pulls fluid from the refill container (730) towards the main reservoir (102). Given that the fluid indicator reservoir (104) and the main reservoir (102) are at the same level, the main reservoir (102) fluid level and the fluid indicator reservoir (104) fluid level rise at the similar rate and eventually equalize to the same level. As the reservoirs (102, 104) fill with print fluid, air is pushed back into the refill container (730) via a vent in the refill port (526). This air allows print fluid to more readily flow out of the refill container (730).

In this example, the fluid level sensors (528) in the main reservoir (102) may control when to shut off the pump (518) to stop refill. In another example, if the refill container is removed during a refill operation, the pump (518) will stop.

In some examples, printing may continue during refill. That is, fluid near the bottom of the air separator (520) may be passed to the printhead (516). When the fluid gets to a certain height, it flows into the main reservoir (102) and the fluid indicator reservoir (104). That is, during refilling, the air separator (520) provides printing fluid to the printhead (516) and refills the main reservoir (102). However, in other examples, the printhead (516) is deactivated such that no fluid flows towards it.

During refilling or during other time when not printing, the print fluid delivery system (100) can recirculate print fluid from the main reservoir (102), fluid indicator reservoir (104), pump (518), air separator (520), and tubes and other components of the fluid transport system (FIG. 1, 106). This may enhance print fluid health by reducing settling of fluid components and replacing water in regions where water vapor has evaporated out of the system.

FIG. 8 is a diagram of a print fluid delivery system (208) with a fluid indicator reservoir (104) during refilling, according to another example of the principles described herein. Specifically, FIG. 8 depicts a point in time when the main reservoir (102) and the fluid indicator reservoir (104) are full. In the event that these reservoirs (102, 104) fill before the refill container (730) is empty, the print fluid delivery system (100) transitions into an overflow operation where excess print fluid is moved back into the supply through the vent line.

As described above in regards to FIG. 7, in this example, print fluid passes from the refill container (730) to the reservoirs (102, 104), through tubes of the fluid transport system (FIG. 1, 106). However, in this example, the fluid level in the reservoirs (102, 104) has risen above the vent line such that print fluid, rather than air, flows through the vent line. This fluid can be recirculated through the pump (518) and other components until an operator stops the pump and/or removes the refill container (730) from the refill port (526).

Such systems and methods 1) enable accurate indication of print fluid levels in a printing system; 2) allow for indicating fluid levels at any location on the printing system; 3) provide for a mechanically simple fluid level indication; and 4) indicate print fluid levels when the printing system is powered on or off.

What is claimed is:

1. A print fluid delivery system, comprising:
a main reservoir to hold a volume of print fluid to be supplied to a printhead;
a fluid indicator reservoir fluidly coupled to the main reservoir, the fluid indicator reservoir to visually indicate a fluid level through an aperture in a printing system housing, wherein the fluid indicator reservoir and the main reservoir have a same fluid level; and
a fluid transport system to transport fluid through the print fluid delivery system.

2. The print fluid delivery system of claim 1, wherein the main reservoir and the fluid indicator reservoir are fluidly coupled via a fluid line coupled at a bottom of each reservoir.

3. The print fluid delivery system of claim 1, wherein the main reservoir and the fluid indicator reservoir are positioned at different locations within the printing system housing.

4. The print fluid delivery system of claim 1, wherein the fluid indicator reservoir is formed of at least one of a transparent material and a translucent material.

5. The print fluid delivery system of claim 1, wherein the fluid transport system comprises fluid lines to transport print fluid from the main reservoir, through the fluid indicator reservoir, and to the printhead.

6. The print fluid delivery system of claim 1, wherein the fluid indicator reservoir and main reservoir are maintained at atmospheric pressure.

7. The print fluid delivery system of claim 6, further comprising a vent line passing through the main reservoir and the fluid indicator reservoir and exposed to the atmosphere.

8. The print fluid delivery system of claim 1, wherein the fluid indicator reservoir is between 20-30% of a size of the main reservoir.

9. The print fluid delivery system of claim 1, wherein:
during refill, a main reservoir fluid level and a fluid indicator reservoir fluid level rise at a similar rate and rest at a same level; and
during printing, the main reservoir fluid level and the fluid indicator reservoir fluid level drop at a similar rate and rest at a same level.

10. A print fluid delivery system, comprising:
a main reservoir to hold a volume of print fluid to be supplied to a printhead;
a fluid indicator reservoir fluidly coupled to the main reservoir, the fluid indicator reservoir to visually indicate a fluid level through an aperture in a printing system housing, wherein:
the fluid indicator reservoir is light-permeable;
the fluid indicator reservoir and the main reservoir re maintained at a same pressure; and
the fluid indicator reservoir and the main reservoir have a same elevation; and
a fluid transport system to:
transport print fluid from the main reservoir to the printhead; and
circulate print fluid through the print fluid delivery system during printing and refilling.

11. The print fluid delivery system of claim 10, further comprising a light source to backlight the fluid indicator reservoir.

12. The print fluid delivery system of claim 10, wherein the fluid indicator reservoir comprises a contrasting back surface.

13. A printing system, comprising:
a housing having a fluid level aperture on a front surface;
a main reservoir to hold a volume of print fluid to be supplied to a printhead;
a fluid indicator reservoir fluidly coupled to the main reservoir via respective floor surfaces, the fluid indicator reservoir to visually indicate a fluid level through the fluid level aperture; wherein:
the fluid indicator reservoir is light-permeable;
the fluid indicator reservoir and the main reservoir have a same elevation; and
the fluid indicator reservoir and the main reservoir are vented to atmosphere; and
a fluid transport system to transport fluid through the print fluid delivery system.

14. The printing system of claim 13, further comprising at least one of:
an air separator;
a fluid pump;
a switch to selectively trigger a refill operation;
a fluid level sensor; and
a pressure control device.

15. The printing system of claim 13, wherein the fluid level sensor is disposed in the fluid indicator reservoir.
